(19) United States
(12) Patent Application Publication
(10) Pub. No.: US 2021/0016306 A1
(43) Pub. Date: Jan. 21, 2021

(54) SPRAYER BOOM SUSPENSION ASSEMBLY

(71) Applicant: AGCO International GmbH, Neuhausen (CH)

(72) Inventor: Joris Jan Hiddema, Grubbenvorst (NL)

(21) Appl. No.: 16/483,504

(22) PCT Filed: Jan. 17, 2018
(86) PCT No.: PCT/EP2018/051133

§ 371 Date: Aug. 5, 2019

(30) Foreign Application Priority Data
Feb. 3, 2017 (GB) 1701778.1

(51) Int. Cl. B05B 9/06

(52) U.S. Cl. CPC B05B 9/06

(57) ABSTRACT

A boom suspension assembly for an agricultural sprayer having a chassis, a lift arm assembly mounted to the chassis, and a boom support frame pendulously suspended from the lift arm assembly. Springs and dampers between the chassis and the boom support frame control pitch and yaw movement of the boom support frame away from a neutral position. The lift arm assembly, boom support frame and dampers provide a four-bar linkage which maintains the boom support frame in a steady alignment when raised and lowered.

### FIELD OF INVENTION

The invention relates to agricultural crop sprayers and particularly to the mounting of a transversely-extending sprayer boom to a chassis of a sprayer machine in a manner which permits raising and lowering of the boom, and also yaw, pitch and roll movement of the boom.

### BACKGROUND

Agricultural sprayers are used by farmers and contractors to apply pesticides and other nutrient-containing solutions to crop fields. Sprayer machines can be mounted to, or towed by, a tractor or other suitable vehicle, or may be self-propelled with an integrated means of propulsion and a driver's cab. The sprayer machine typically includes a storage tank for the liquid to be applied, the tank being filled as required by the operator. However, it is also known to supply the liquid to the sprayer machine via a supply pipe connected to a remote bowser for example.

The liquid is applied to the field by a number of liquid application devices, commonly spray nozzles, which are mounted in a spaced relationship along the length of a deployable boom which, itself, is mounted to the chassis of the sprayer machine. The application devices are each connected to the storage tank by liquid delivery means comprising various pipes, valves, pumps and other plumbing. The liquid is atomised by the nozzles and applied to the crop in a jet of mist for example.

The sprayer boom is typically foldable into a transport position and ranges from 10 to 40 metres in length when deployed in the field. The boom is supported in a central region by a boom suspension assembly which mounts the boom to the machine chassis. Folding side boom assemblies are mounted to respective sides of the central region and extend transversely away therefrom when unfolded. This leaves a significant portion of the boom unsupported when fully extended and relies on only the rigidity of the boom structure to remain in position.

As the sprayer machine is driven across a crop field the extended boom experiences forces in several directions due to uneven ground and vehicle accelerations. In order to avoid undue stress being placed upon the boom suspension assembly it is known to suspend the boom in a manner that permits yaw, pitch and roll movements of the boom with respect to the chassis.

‘Yaw’ is pivoting movement of the boom around a central vertical axis. In other words, the left-hand side of the boom moves forwards whilst the right-hand side moves rearwards. Excessive yaw movement can result in uneven application of the spray to areas of the field. ‘Pitch’ is movement of the entire boom about a lateral or transverse axis and typically results from acceleration or deceleration of the vehicle. Excessive yaw movement can also result in uneven spray application. ‘Roll’ is movement of the boom around a longitudinal axis and typically results from the vehicle being driven over uneven terrain. Left uncontrolled, excessive roll can result in the extremities of the boom striking the ground thus risking damage to both the boom and the crop.

Oscillations in any direction can increase in amplitude to the extent where the machine must be stopped and restarted leading to inconvenience for the operator and an inefficient working approach.

To control the oscillations and movement of the boom extremities damping means are often provided to damp movement of the boom mounting assembly relative to the chassis. Springs may also be provided together with the dampers to bias the movements back to a neutral position. Attempts have been made to control the various oscillations in a boom resulting in rather complex suspension and damping systems. Although capable of controlling movements of the boom, known systems comprise many components adding to the overall weight and complexity of the assembly.

### SUMMARY OF THE INVENTION

According to an aspect of the invention there is provided a sprayer boom suspension assembly comprising a chassis, a lift arm assembly mounted to the chassis, a boom support frame pendulously suspended from the lift arm assembly, and first and second damper means each connected at one end to the chassis and at an opposite end to the boom support frame in a laterally spaced-apart relationship, wherein the damping means are configured to damp swinging movement of the boom support frame relative to the lift arm assembly.

By suspending the support frame directly from the lift arm assembly, and connecting the damping means between the support frame and the chassis, the need for an intermediate frame is avoided resulting in a significant cost and weight reduction. Furthermore, the oscillation-based stresses placed upon the lift arm assembly in conventional suspension assemblies are transferred to the chassis which is better placed to handle such and delivers a more robust geometry.

The damped swinging movements may be around one of more movement axes. The damping means serve predominantly to damp yaw and pitch oscillations of the support frame with respect to the chassis (and lift arm assembly), although a small degree of damping of roll movement may also be delivered.

Each of the first and second damping means preferably comprises a damping cylinder connected to the chassis so that one end of the cylinder is coupled in a fixed positional relationship to the chassis independent of the position of the lift arm assembly. By connecting the damping cylinders to the chassis on the forward side of the boom, the cylinders are protected to some extent from the applied chemicals which may be corrosive. The damping cylinders may be gas-charged cylinders or, alternatively, hydraulic cylinders.

In one embodiment each of the first and second damping means further comprises a bell crank pivotally mounted to the chassis, wherein the damping cylinder is connected between the chassis and a first arm of the bell crank, and a tie rod is connected between a second arm of the bell crank and the boom support frame. The bell crank permits the damping cylinders to be mounted with more of a vertical component which improves the effectiveness and performance of the cylinders.

The damping means preferably further comprises one or more springs or cushions secured to the chassis to act upon the bell crank and limit the extent of the yaw and pitch oscillations and bias the support frame back into a neutral position.

In a preferred arrangement the boom support frame is pendulously suspended from the lift arm assembly by a ball joint which permits yaw, pitch and roll movements around respective pivot axes that pass through the ball joint. Alternatively, the ball joint may be replaced with two or more articulating joints which permit at least yaw and pitch movement of the boom support frame.

In one embodiment the lift arm assembly comprises a lift arm pivotally mounted to the chassis for pivoting lifting and lowering movement about a transverse axis, wherein the boom support frame is pendulously suspended from the lift arm. The lift arm may be centrally located with respect to a transverse machine axis. Furthermore, a lift cylinder may be provided to act between the chassis and the lift arm to control the height of the boom support frame suspended therefrom.

Further damping means may be provided between the boom support frame and the lift arm assembly to control roll movements or oscillations.

The boom suspension assembly may be adapted for integration onto an agricultural crop sprayer which may be a tractor-mounted sprayer, a pull-type sprayer or a self-propelled sprayer by way of example.

### BRIEF DESCRIPTION OF THE DRAWINGS

Further advantages of the invention will become apparent from reading the following description of specific embodiments with reference to the appended drawings in which:—

FIG. 1 show a front perspective view of a pull-type agricultural crop sprayer having a boom suspension assembly in accordance with an embodiment of the invention, shown with part of the tank cut away and without a boom;

FIG. 2 shows a rear perspective view of the boom suspension assembly of FIG. 1 in isolation;

FIG. 3 shows a close up view of part of the boom suspension assembly of FIG. 1;

FIG. 4 shows another close up view of part of the boom suspension assembly of FIG. 1;

FIGS. 5A and 5B show a side elevation of the boom suspension assembly of FIG. 1, showing the lift arm in a raised position and a lowered position respectively;

FIGS. 6A and 6B show a rear elevation of the boom suspension assembly of FIG. 1, showing the boom support frame in a roll-neutral position and a roll-offset position respectively; and,

FIGS. 7A and 7B show a view from above of the boom suspension assembly of FIG. 1, showing the boom support frame in a yaw-neutral position and a yaw-offset position respectively.

### DETAILED DESCRIPTION OF SPECIFIC EMBODIMENTS OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Reference to terms such as longitudinal, transverse and vertical are made with respect to a longitudinal vehicle axis which is parallel to a normal forward direction of travel.

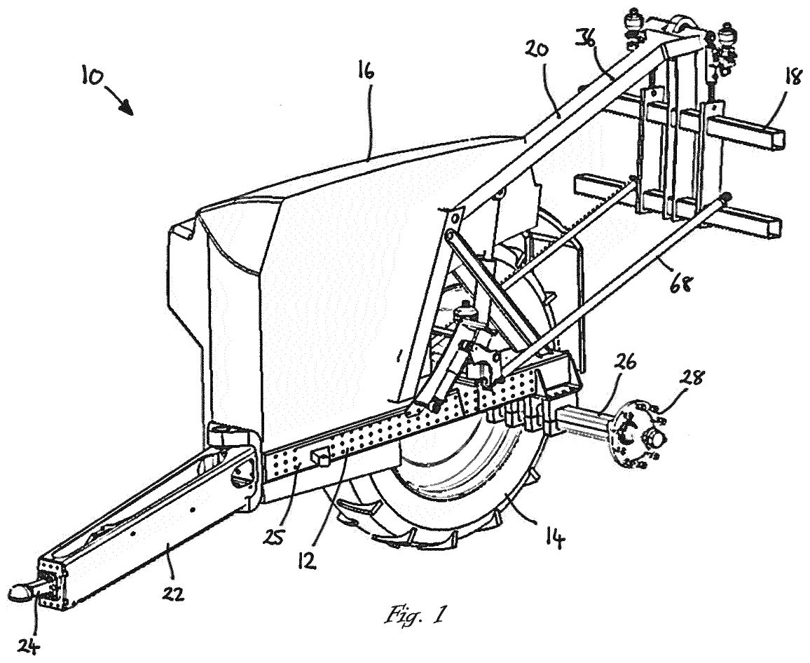

With reference to FIG. 1 a pull-type, or trailed, sprayer 10 comprises a chassis 12, ground engaging wheels 14, a storage tank 16 and a boom support frame 18 suspended from a lift arm assembly 20. It should be appreciated that the storage tank 16 is cut away in FIG. 1, and the left-hand wheel omitted from view to reveal details of the sprayer boom assembly.

The pull-type sprayer 10 is configured to be attached to the rear of an agricultural tractor by means of a hitch tongue 22 and drawbar attachment device 24 secured to the front end of chassis 12. The sprayer 10 is suitable for use by farmers to apply pesticide and other nutrient-containing solutions to agricultural crop fields.

The chassis 12 comprises a central, rigid longitudinally-extending frame member 25 which supports the weight of the tank 16 and the sprayer boom suspension assembly 18,20. The frame member 25 is centrally aligned with respect to the centre of mass of the sprayer 10 so that a substantially equal weight resides to the left and right sides of the frame member 25.

Although shown and described as having a single longitudinal member 25, the chassis 12 may, in alternative configurations, comprise further weight-bearing components without deviating from the scope of the invention.

A single, transversely-extending, axle 26 is shown mounted to the underside of frame member 25, the axle 26 including outboard wheel hubs 28 for carrying the wheels 14. In alternative embodiments further wheeled axles may be provided.

The storage tank 16 serves to hold the liquid to be applied to the crop field. For example, the liquid may be a pesticide formulation or a nutrient-containing solution. The storage tank may be moulded from plastic and is preferably shaped so as to surround the lift arm assembly 20 without inhibiting the operation thereof. The storage tank may also comprise a plurality of separate storage tanks or integrated compartments which serve to carry an on-board supply of clean water for rising the main chemical tank after use.

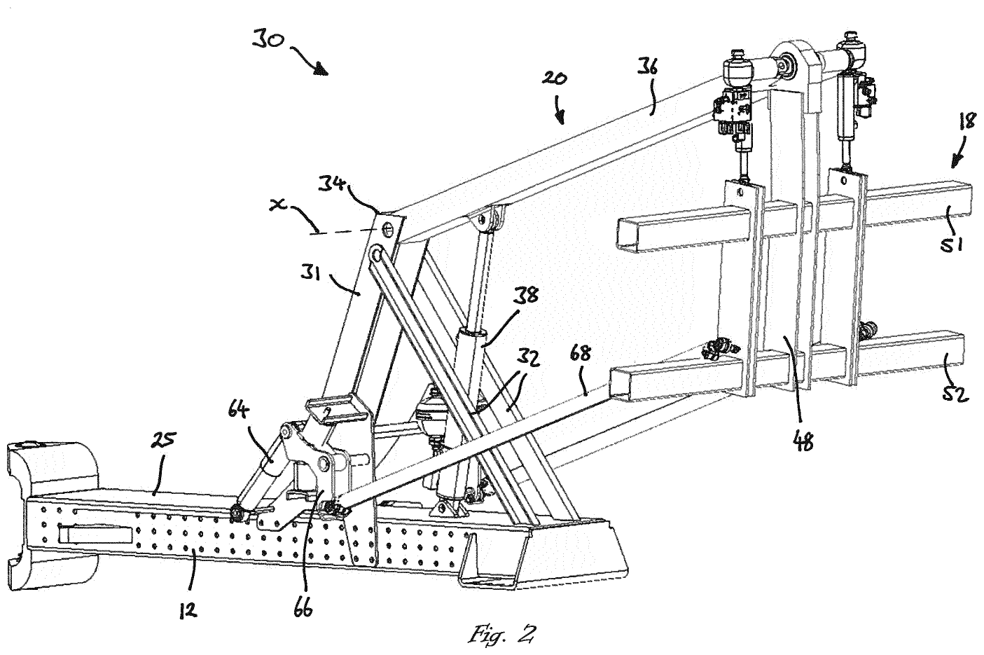

Turing to attention to FIG. 2 a sprayer boom suspension assembly 30 in accordance with a first embodiment of the invention comprises the chassis 12, the lift arm assembly 20 and the boom support frame 18. FIG. 2 shows the sprayer boom suspension assembly 30 in isolation to assist with a clear description of the component parts to follow below.

The lift arm assembly 20 comprises a triangulated support structure having a rearwardly-leaning post 31 secured to the frame member 25 and a pair of transversely-spaced stabilizing members 32 to triangulate between the post 31 and frame member 25. The support structure 31,32 is fixed to the chassis 12 and provides an elevated mounting point 34 for a lift arm 36. Although treated as a fixed component of the lift arm assembly 20, the support structure 31,32 may be considered as forming part of the chassis 12.

Lift arm 36 is pivotally mounted to post 31 in a manner which allows pivoting lifting and lowering movement about a transverse lift axis ‘x’. Lift arm 36 is raised and lowered by means of a lift cylinder 38 which is pivotally connected at each end between the frame member 25 and a bracket provided on the underside of lift arm 36.

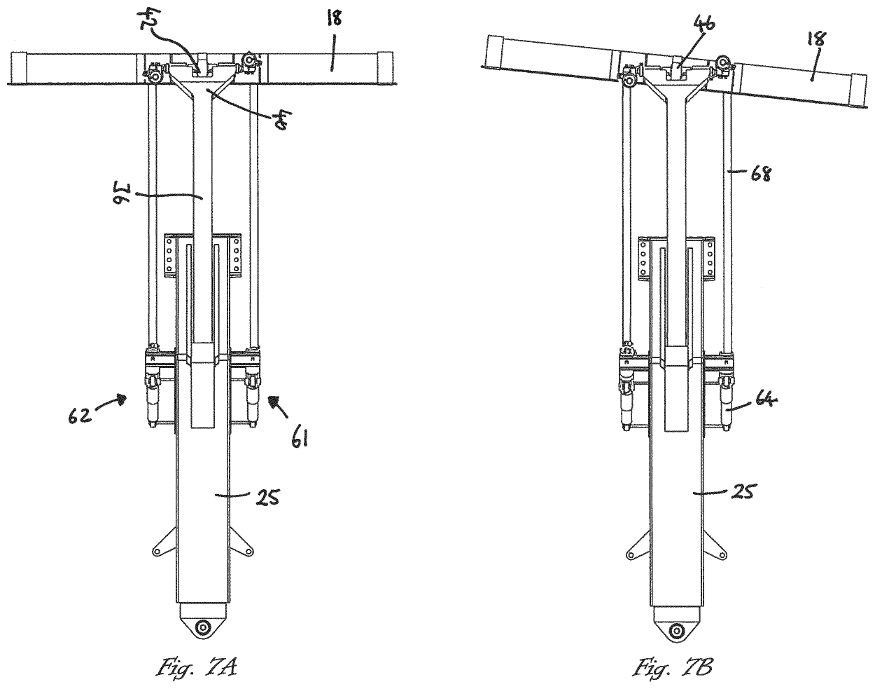

Lift arm 36 extends rearwardly from the pivot axis x and terminates at its rearmost-end with a Y-shaped portion 40 as best seen from above in FIG. 7a. The Y-shaped portion 40 comprises a pair of flared-out portions 41 separated by a void 42 which accommodates a transverse pin 44 (secured between the flared portions 41) and a ball joint 46.

The boom support frame 18 is pendulously suspended from the lift arm assembly 20 by the ball joint 46 which is mounted upon transverse pin 44. The ball joint 46 is received inside a bore formed in an upright central member 48 which forms a central spine of the boom support frame 18. The upright 48 may include a cast top portion 49 in which the ball joint-receiving bore is machined. The boom support frame 18 as best seen in FIG. 2 also includes pair of vertically-spaced transverse tubular members 51,52 which are secured to the upright member 48.

It should be recognised that the boom support frame 18 may be constructed in a host of different ways and need not necessarily, for example, include a pair of transverse tubes or a lattice-type structure as described above. The boom support frame 18 preferably serves to carry and support a folding multi-section sprayer boom which, in one embodiment, includes a central boom section fixed with respect to frame 18 and multi section wings which are pivotally mounted to outboard ends of frame 18. However, it should be understood that the invention relates to the manner in which the boom and boom support frame 18 is mounted to the chassis 12 and further details of the boom and boom support frame construction are not pertinent to the understanding of the invention.

The ball joint 46 permits the boom support frame 18 to pitch about a transverse axis, to yaw about a vertical axis, and to roll about a longitudinal axis, the respective axes passing through the ball joint 46. In accordance with an aspect of the invention spring and damping apparatus are provided to control pitch yaw and roll movement of the boom support frame 18 and, ultimately, the boom mounted thereto (not shown).

Pitch and yaw movement of the boom support frame 18 is controlled by first and second damper assemblies, designated 61 and 62 indicated in FIG. 7a. First damping assembly 61 is positioned on the left-hand side of chassis 12 whilst the second damper assembly is positioned on the right-hand of chassis 12. Each of the first and second damper assemblies 61,62 are similar in construction and the following description of first damper assembly 61 applies also to the second damper assembly 62.

With reference to FIGS. 2 and 4, damper assembly 61 includes a damping cylinder 64, a bell crank 66 and a tie rod 68. The cylinder 64 is connected at one end 69 to an anchor point provided by chassis 12 and pivotally connected at the other end 70 to a forwardly-extending leg 72 of bell crank 66.

The bell crank 66 is pivotally mounted to an upright plate 73 which itself is secured to frame member 25 and forms part of chassis 12. The pivoting joint 74 defines a pivot axis around which bell crank 66 can pivot, the pivot axis extending generally transversely.

A second leg 76 of the bell crank 66 has connected thereto the tie rod 68 which extends therefrom in a generally rearward direction and is coupled to the boom support frame 18 at position that is laterally spaced away central upright member 48.

The construction of bell crank 66 is shown as comprising a pair of parallel spaced plates which provide a channel therebetween to receive the respective ends of damper 64 and tie rod 68. However, it should be appreciated that the bell crank 66 may take other constructions and may, for example, be a solid cast member with machined portions to make the necessary couplings.

In a not illustrated embodiment the damping assemblies omit the bell crank. In such an arrangement a damping cylinder may be integrated with, or coupled to the tie rod 68 that extends from the boom support frame 18 to the chassis 12.

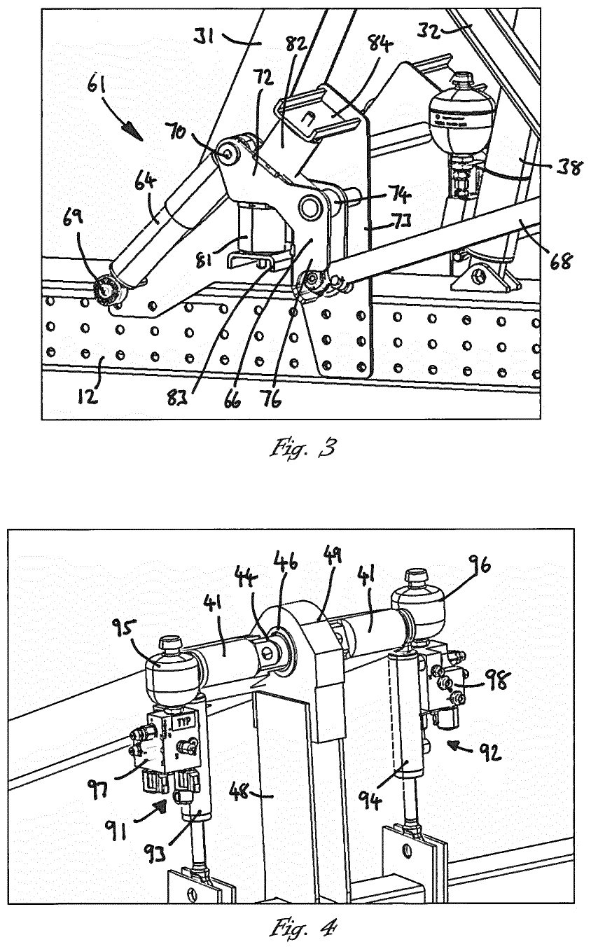

Turning back to the illustrated embodiment, pitch and yaw movement of the boom and boom support frame 18 is transferred via the tie rod 68 and bell crank 66 to the damping cylinder 64. Such movement is restricted by the provision of springs in the form of a pair of rubber cushions 81,82 which are each secured to a respective mounting plate 83,84 which protrude outwardly from upright plate 73. The cushions 81,82 abut opposing sides of the first bell crank leg 72. When displaced away from the neutral position shown in FIG. 3 the cushions 81,82 flex to absorb the movement and serve to bias the bell crank 66, and ultimately the boom support frame 18, back in to the neutral position.

The cushions 81,82 serve as springs to bias the boom support frame 18 into the neutral position when displaced therefrom. It should be appreciated that the rubber cushions 81,82 may be replaced with other types of spring without deviating from the scope of the invention. Moreover, the springs may act upon other parts of the suspension assembly to counteract yaw and pitch movements. For example, a pair of springs may act directly upon the boom support frame 18.

Roll movement of the boom support frame 18 is controlled by spring-damper devices 91,92 which are best seen in FIG. 4 and are each connected between the flared portions 41 and the boom support frame 18 at positions laterally spaced from the upright member 48. The spring-damper devices 91,92 include respective hydraulic cylinders 93,94 each having an accumulator 95,96 connected thereto to provide the spring/damper function. Each device 91,92 also includes a respective valve block 97,98 connected to hydraulic control apparatus (not shown) for control of the cylinders 93,94 in a manual or automatic levelling function. In other words, the devices 91,92 also permit control of the roll angle of the boom support frame 18 with respect to the chassis 12.

The direct suspension of the boom support frame 18 from the lift arm assembly 20, and the direct connection of the damping means between the boom support frame 18 and chassis 12 delivers a lightweight yet robust sprayer boom suspension assembly without the need for an intermediate sub-frame.

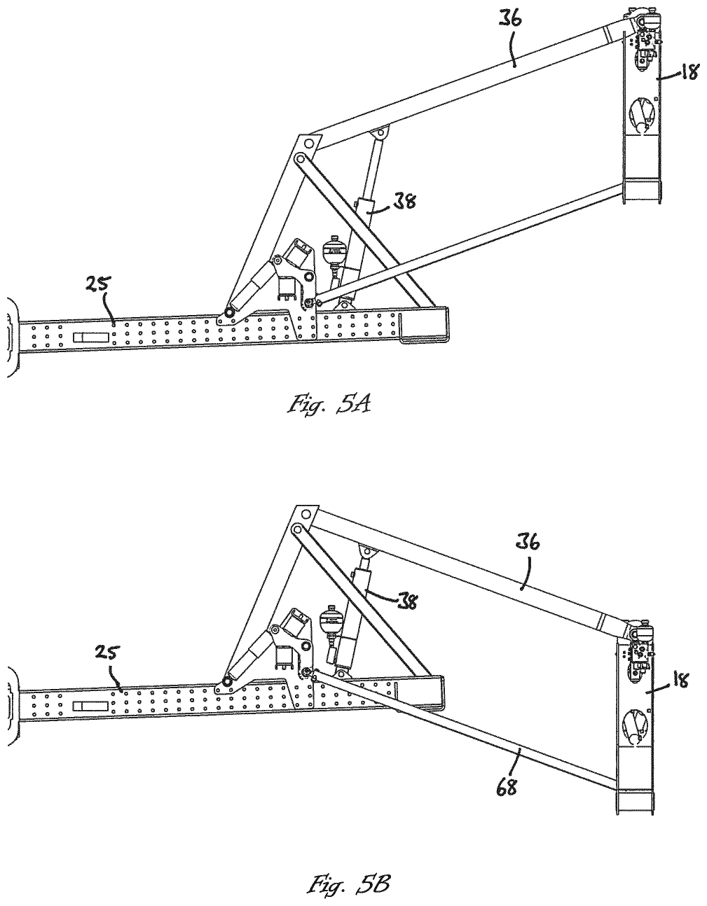

With reference to the FIGS. 5a and 5b, the lift arm 36 and tie rod 68 provide a four-bar linkage arrangement which keeps the boom support frame 18 substantially upright throughout the range of movement provided by the lift arm assembly 20.

FIG. 5a shows the boom support frame 18 in a fully raised position whilst FIG. 5b shows the boom support frame 18 in a fully lowered position wherein the boom support frame 18 is maintained substantially upright throughout. The tie rods 68 pivot at both ends so that there is no force transmitted to the respective bell cranks 66 as the boom support frame 18 is raised and lowered.

It should be appreciated that the side view provided in FIGS. 5a and 5b hides the right-hand tie rod 68. Furthermore, the boom support frame 18 is shown covered by a protective shell which is omitted in FIGS. 1,2 and 4.

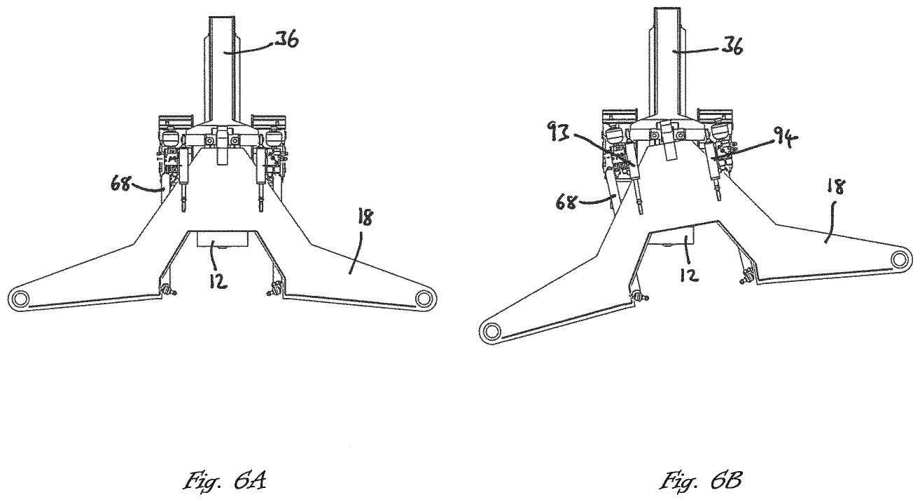

FIGS. 6a and 6b illustrate roll movement of the (covered) boom support frame 18 wherein FIG. 6a shows a neutral position and FIG. 6b shows roll displacement anti-clockwise round a longitudinal roll axis. The tyre rod 68 are pivotally coupled at each end which permits the first and second damping assemblies 61,62 to cater for the roll movement. At the same time the spring damper devices 91,92 serve to control and damp the roll movement. As can be seen in FIG. 6b the hydraulic cylinders 93,94 are extended with different lengths as the roll displacement occurs.

FIGS. 7a and 7b show a view of the boom suspension assembly 30 from above and illustrate yaw movement of the boom support frame 18 around a vertical axis passing through ball joint 46. Together the figures show that the first and second damping assembly 61,62 can cater for the yaw or twisting movement of the boom with compressive forces on one tie rod 68 at the same time as tensile forces are exerted via the opposite tie rod.

In summary, there is provided a boom suspension assembly for an agricultural sprayer comprising a chassis, a lift arm assembly mounted to the chassis, and a boom support frame pendulously suspended from the lift arm assembly. Spring and damping means are provided between the chassis and the boom support frame to control pitch and yaw movement of the boom support frame away from a neutral position. The lift arm assembly, boom support frame and the damping means provide a four-bar linkage which maintains the boom support frame in a steady alignment when raised and lowered.

From reading the present disclosure, other modification will be apparent to persons skilled in the art. Such modifications may involve other features which are already known in the field of sprayer boom suspensions and component parts therefore and which may be used instead of or in addition to features already described herein.

1. A sprayer boom suspension assembly comprising:
a chassis;
a lift arm assembly mounted to the chassis;
a boom support frame pendulously suspended from the lift arm assembly; and
first and second dampers each connected at one end to the chassis and at an opposite end to the boom support frame in a laterally spaced-apart relationship, wherein the dampers are configured to damp swinging movement of the boom support frame relative to the lift arm assembly.

2. The sprayer boom suspension assembly according to claim 1, wherein each of the first and second dampers comprises a damping cylinder connected to the chassis.

3. The sprayer boom suspension assembly according to claim 2, wherein each of the first and second dampers further comprises a bell crank pivotally mounted to the chassis, wherein the damping cylinder is connected between the chassis and a first arm of the bell crank, and a tie rod is connected between a second arm of the bell crank and the boom support frame.

4. The sprayer boom suspension assembly according to claim 3, wherein each of the first and second dampers further comprises a spring or cushion secured to the chassis and which acts upon the bell crank.

5. The sprayer boom suspension assembly according to claim 1, wherein the boom support frame is pendulously suspended from the lift arm assembly by a ball joint.

6. The sprayer boom suspension assembly according to claim 1, wherein the lift arm assembly comprises a lift arm pivotally mounted with respect to the chassis for pivoting lifting and lowering movement about a transverse lift axis, and wherein the boom support frame is pendulously suspended from the lift arm.

7. The sprayer boom suspension assembly according to claim 6, wherein the lift arm assembly further comprises a lift cylinder configured to act between the chassis and the lift arm.

8. The sprayer boom suspension assembly according to claim 6, wherein the lift arm is positioned centrally with respect to a lateral boom axis.

9. The agricultural sprayer machine comprising a sprayer boom suspension assembly according to claim 1, and a foldable sprayer boom assembly mounted to the boom support frame.

10. The agricultural sprayer machine according to claim 9, comprising a pair of ground-engaging wheels mounted to the chassis, wherein the first and second dampers extend from the chassis to the boom support frame in a space between the pair of ground-engaging wheels, at least when the lift arm assembly is in a lowered position.
